(19) United States
(12) Patent Application Publication
(10) Pub. No.: US 2009/0045036 A1
(43) Pub. Date: Feb. 19, 2009

(54) DRIVEN TRANSPORTING ROLLER WITH CIRCUMFERENTIAL MARKINGS

(76) Inventors: Thomas Rumpf, Roemerberg (DE); Berthold Eitzenberger, Ludwigshafen/Rhein (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/658,664

(22) PCT Filed: Jul. 5, 2005
(86) PCT No.: PCT/EP2005/007249

§ 371 Date: Sep. 17, 2008

(30) Foreign Application Priority Data
Jul. 26, 2004 (DE) 10 2004 036 150.9

(51) Int. Cl. B65G 13/06

(52) U.S. Cl. 198/789

(57) ABSTRACT

The invention relates to a transporting roller with a drive unit assigned thereto, wherein the transporting roller (1) has a circumferential surface area (2) of an elastic material (18, 19, 20). The transporting roller (1) rotates about an axis of rotation (3) and is accommodated in the housing (17) of the drive unit. The transporting roller (1) contains at least one colored marking body (11), which is visible in the circumferential surface area (2), is composed of an elastic material and the abrasion properties of which correspond to those possessed by the elastic material (18, 19, 20) of the circumferential surface area.

### TECHNICAL FIELD

In freight loading systems or conveying devices for freight containers, containers or the like, said containers or the like are often conveyed on driven cylinders or on ball mats, roller tracks or the like. The driven cylinders generally have a rubberized surface in order to assist the conveying of objects, such as, for example, the abovementioned freight containers, or goods on pallets or other bulky objects into certain setting positions or to certain processing stations.

### PRIOR ART

In freight loading regions of transport ships, hovercrafts, aircraft, trucks or on transporting devices in industrial plants, transporting rollers which are sometimes driven and sometimes not driven are embedded into the floor surface of the freight loading compartment in order to permit transportation of bulky objects, such as, for example, containers or palletized piece goods or the like within the freight compartment and to bring them to specific setting positions. The freight items are generally locked at these setting positions such that they are not displaced during transportation.

In aircraft, use is made, for example in freight loading regions, of roller tracks or ball mats which have driven drive units (PDUs) at certain distances from one another. These drive units are generally assigned at least one driven roller which is provided with an elastic circumferential surface and permits automatic transportation of an item of freight, such as, for example, a freight container or palletized freight or the like, along the roller track or along the ball mats to a defined setting position, at which the freight container or the palletized piece goods can be locked. After locking of the item of freight, the relative movement thereof during transportation, such as, for example, during the flight, is eliminated and damage, for example to the inside of the fuselage, can therefore be effectively prevented.

A multiplicity of drive units are integrated into the floor of a freight compartment, for example of an aircraft, and therefore the entire floor surface of the freight compartment is uniformly provided with driven transporting rollers. As a result, the transporting of the container to certain setting positions at every location in the freight compartment is possible.

The driving rollers which are integrated into the floor of the freight compartment are always relatively difficult to see. As a consequence of wear and attrition on the circumference of the driven transporting roller, the contrast between the transporting roller and the surroundings becomes even more blurred. Soiling which occurs during the operation of the aircraft and is caused by the continuous unloading and loading makes it difficult for the transporting rollers to be able to be seen clearly, for example in poorly illuminated loading compartments. In environments with considerable noise, running noises and rotational movement of the rollers can only be perceived to a reduced extent or not at all. In particular, it is hardly possible to see whether, when the transporting drive units are switched on in a system check, the transporting rollers are rotating or whether one of the drive units integrated into the floor of the freight loading compartment has failed. In addition, in poorly illuminated and heavily soiled freight loading compartments, it is scarcely possible to see whether the driven transporting rollers have reached their wear limit or not. The wear limit of the coating of the transporting rollers can only be determined with specific checks during the inspection of the freight compartment, for example with the aid of measuring tools or gauges. An additional difficulty is that the circumferential surface of the transporting rollers may abrade nonuniformly.

### SUMMARY OF THE INVENTION

The present invention is based on the object of checking, within a simple system check, whether all of the driven transporting rollers are rotating and whether one of the transporting rollers has reached its wear limit.

This object is achieved by the features of patent claim 1.

The solution proposed according to the invention affords the advantage that the running surface of the transporting roller, which surface is generally composed of an elastic material, is partially pierced by, for example, at least one marking body, for example a pin, which is vulcanized in and is provided with a contrasting color, as a result of which it is ensured that as large a vulcanizing surface as possible can be retained. The strength properties of the running surface are thereby very substantially retained. Furthermore, it is advantageous that the entire running surface of the transporting roller is manufactured from standard materials which are merely colored in differently, or else are luminous in daylight (fluorescent). The integration proposed according to the invention of a marking body, for example a pin of rubber, which is set off in a colored manner, furthermore affords the advantage, which is relevant in terms of manufacturing, that the running surface of the transporting rollers need be drilled open at only at least one location, which is simpler and more cost-effective than, for example, vulcanizing differently colored running surfaces of a transporting roller circumferential surface such that they lie one above another. The solution proposed according to the invention is therefore also very simply possible for retrospective fitting in transporting rollers which have already been supplied and which are to be equipped with a marker indicating the rotation and degree of wear. With one and the same pin, such as, for example, a rubber pin, which is integrated into the running surface at, for example, two opposite locations and is set off in a colored manner, both the rotation of the transporting rollers, and therefore the functional capability of a drive unit (PDU) and the degree of wear of the running surface of the driven transporting roller can be determined.

### DRAWING

The invention is described in more detail below with reference to the drawing, in which:

FIG. 1 shows a first transporting roller half of a driven transporting roller of divided design,

FIG. 2 shows the second transporting roller half of a transporting roller of divided design, which half can be fitted to the first transporting roller half illustrated in FIG. 1, and

FIG. 3 shows the transporting roller, which is accommodated in a housing of a drive unit, with marking bodies located in the circumferential surface area.

### VARIANT EMBODIMENTS

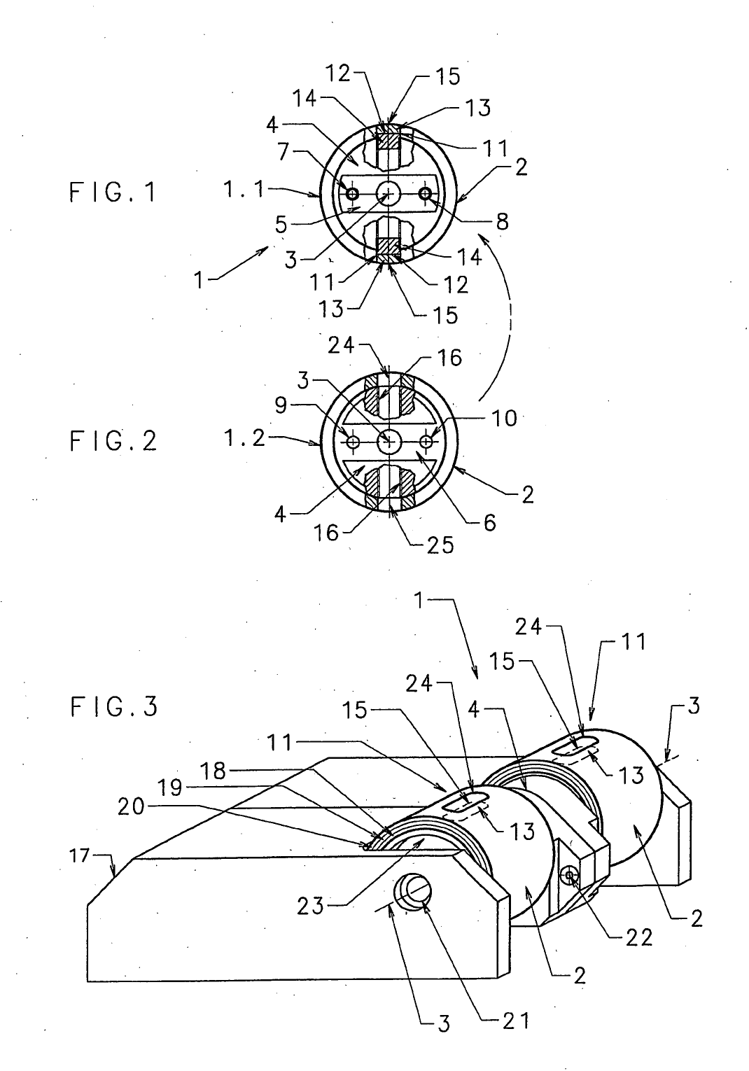

A first transporting roller half of a driven transporting roller of divided design can be seen in the illustration according to FIG. 1.

A transporting roller 1 of divided design comprises the first transporting roller half 1.1, which is illustrated in FIG. 1, and the second transporting roller half 1.2, which is illustrated in FIG. 2 and is designed in a complementary manner to the first transporting roller half 1.1.

The fact that the first transporting roller half 1.1 together with the second transporting roller half 1.2 forms a transporting roller 1 is symbolized by the arrow indicated between FIGS. 1 and 2.

The first transporting roller half 1.1 has a circumferential surface area 2 and rotates about its axis of rotation 3. Reference number 4 indicates a dividing joint at which, in the fitted state of the first transporting roller half 1.1 and of the second transporting roller half 1.2, the transporting roller halves 1.1 and 1.2 can bear against each other. In the first transporting roller half 1.1, a web 5 is formed which interacts with a recess 6, which is complementary thereto, of the second transporting roller half 1.2 illustrated in FIG. 2. A first pin 7 and a second pin 8, which are arranged on the web 5, are formed on the first transporting roller half 1.1. The first pin 7 and the second pin 8 interact with corresponding openings 9 and 10 in the recess 6 on the second transporting roller half 1.2. Each of the transporting roller halves 1.1 and 1.2 has parts of receiving openings 24 and 25 for receiving marking bodies 11. In the illustration according to FIG. 1, the marking bodies 11, which are of pin-shaped design, are embedded into those portions of the first and second receiving openings 24, 25 which are formed in the first transporting roller half 1.1. The marking bodies 11 are bodies which are of pin-shaped design, are composed of an elastic material and have two colored portions 13 and 14 which are colored in or colored differently. Each of the marking bodies 11 has a head 15 which is located in the circumferential surface area 2 of the transporting roller 1 of divided design. A first colored portion 13 is colored in green, for example, whereas a second colored portion 14 is colored in in red. The properties of elasticity of the material of the marking bodies 11 preferably correspond to those of the elastic material of which the circumferential surface area 2 of the transporting roller 1 of divided design is composed.

FIG. 2 shows the second transporting roller half of a transporting roller which is of divided design and can be fitted to the first transporting roller half, illustrated in FIG. 1.

The marking bodies 11, which can be of pin-shaped design, can be, for example, adhesively bonded into the first receiving opening 24 and the second receiving opening 25. Furthermore, it is also possible to fasten the marking bodies 11, which can be of pin-shaped design, in the first and second receiving openings 24, 25 by means of a thread 16. Account can therefore be taken of the fact that, at high driving speeds of the transporting roller 1 of divided design, the marking bodies 11 are reliably held in the first receiving opening 24 and the second receiving opening 25 and withstand the centrifugal forces which occur.

The second transporting roller half 1.2, illustrated in FIG. 2, has a recess which corresponds to the web 5 of the first transporting roller half 1.1. The first opening 9 and the second opening 10 for receiving the pins 7 and 8 of the web 5 of the first transporting roller half 1.1 are formed within the recess 6.

The second transporting roller half 1.2 also has a circumferential surface area 2 of an elastic material.

If the transporting roller halves 1.1 and 1.2 illustrated in FIGS. 1 and 2 are joined to each other in accordance with the arrow, then the web 5 is located in the recess 6 and the pins 7, 8 enter the openings 9 and 10, respectively. In the illustrations according to FIGS. 1 and 2, two mutually opposite receiving openings 24, 25 are illustrated in the transporting roller 1 of divided design. As an alternative, it is, of course, also possible to form three or four receiving openings 24, 25 in the transporting roller 1 of divided design. The marking bodies 11, which can be of pin-shaped design, may be inserted into the rubber coating of the transporting roller 1 of divided design. Since the head 15, which is colored in green, for example, is located in the circumferential surface area 2 of the transporting roller 1 of divided design, said head shows the rotation of the transporting roller 1 during the rotation of the transporting roller 1, which is of divided design, by the drive unit assigned to it. The coloring of the first colored portion 13 is selected such that it differs from the coloring of the circumferential surface area 2 and a sharp contrast is caused. If the marking bodies 11, which can be of pin-shaped design, together with the circumferential surface area 2, which surrounds them, of the transporting roller 1 of divided design are abraded to a defined degree, then the second colored portion 14 of the marking bodies 11 of pin-shaped design becomes visible, which colored portion is colored in differently than the first colored portion 13, for example in red. As soon as the second colored portion 14, which is retained in red, of the pin-shaped marking body 11 becomes visible through the circumferential surface area 2, the reaching of the wear limit of the particular driven transporting roller 1 of divided design at least one location on its circumference is signaled.

A divided transporting roller which is embedded into the housing of a drive unit can be gathered from the illustration according to FIG. 3.

It is revealed from the illustration according to FIG. 3 that the transporting roller 1 of divided design rotates about its axis of rotation 3. The two parts of the transporting roller 1 of divided design butt against each other along the dividing joint 4; in addition, in the variant embodiment illustrated in FIG. 3, they are fixed to each other via a clamping screw 22. The metallic basic bodies 23 of the transporting roller 1 of divided design can be provided, for example, with a first layer 18 vulcanized onto it, a second layer 19 vulcanized onto it, and a third layer 20 which is vulcanized onto it and forms the circumferential surface area 2. The head 15 of the marking body 11, which can be of pin-shaped design for example, is located in the vulcanized layer 20 forming the circumferential surface area 2. It is revealed from the illustration according to FIG. 3 that the first receiving opening 24 for receiving the marking bodies 11, which can be of pin-shaped design, can also be designed as a slot. In the illustrations according to FIGS. 1 and 2, after the two transporting roller halves 1.1 and 1.2 are joined together, a circular receiving opening 24 or 25 is produced. The second colored portion 14 (not illustrated in FIG. 3) then first becomes visible when the third vulcanized layer 20, the second vulcanized layer 19 and parts of the first vulcanized layer 18 are abraded due to operation and, accordingly, the transporting roller 1 of divided design has reached its wear limit. This is signaled visually by the appearance of the second colored portion 14.

The marking bodies 11, which are embedded into the receiving openings 24, 25 and can be of pin-shaped design, are preferably manufactured from a material which has identical properties to the abrasion parameters of the vulcanized layers 18, 19, 20. The marking bodies 11 can either be vulcanized into the openings 24, 25 or else can be screwed and subsequently adhesively bonded into the latter, in accordance with the illustration in FIG. 2. By means of the solution proposed according to the invention, when the marking body 11 is vulcanized in, the circumferential surface area 2 of the transporting roller 1 is only partially pierced while at the same time the vulcanizing surface is retained to the greatest possible extent. This assists the strength properties of the circumferential surface area 2. The solution proposed according to the invention is also eminently suitable for retrofitting drive units which have already been used, since the circumferential surface area 2 thereof is, for example, simpler and more cost-effective to drill open than vulcanizing differently colored running surfaces such that they lie one above another.

The marking bodies 11, which are described in conjunction with FIGS. 1, 2 and 3 and are of pin-shaped design, may be both of cylindrical design and may have an oval cross section corresponding, for example, to the cross section of the first receiving openings 24 illustrated in FIG. 3. In the as yet unused state of the pin-shaped marking bodies 11 embedded into the first and second receiving openings 24, 25, the head 15 thereof is located flat in the outermost layer of the circumferential surface area 2 of the transporting rollers 1 and does not protrude in a raised manner above the latter. This avoids imbalances during the rotation of the driven transporting rollers 1. Although transporting rollers 1 of divided design are illustrated in FIGS. 1 and 2 and in the fitted state according to FIG. 3, it is also conceivable to configure the transporting roller 1 in such a manner that it is formed without a dividing joint 4 and spans the side members of the driven transporting unit (illustrated in FIG. 3) without the interconnection of a web. The illustrations according to FIGS. 1 and 2 show marking bodies 11 which are of pin-shaped design and are embedded at mutually opposite positions into the transporting roller halves 1.1 and 1.2 of divided design. As an alternative to the arrangement, illustrated in FIGS. 1 and 2, of the marking bodies 11 of pin-shaped design in the transporting roller halves 1.1 and 1.2, the arrangement thereof at an angular offset of 120° from each other with respect to the axis of rotation 3 of the transporting roller halves 1.1 and 1.2 would also be conceivable.

The illustration according to FIGS. 1 and 2 reveals that the marking bodies 11 of pin-shaped design are integrated with their respective head 15 into the transporting roller halves 1.1 and 1.2 in accordance with the curvature of the circumferential surface area 2. According to the illustrations in FIGS. 1 and 2, the first colored portion 13 of the marking bodies 11, which are of pin-shaped design, is designed to be less thick than the second colored portion 14 of the marking bodies 11 of pin-shaped design. Of course, it is also possible, taking the respective conditions of use of the transporting rollers 1 into consideration, to design the first colored portion 13 to have a greater thickness than illustrated in FIGS. 1 and 2, for example approximately the thickness of the second colored portion 14 according to FIGS. 1 and 2. In accordance with the configuration of the thickness of the first colored portion 13 of the marking body 11 of pin-shaped design, the exchange intervals of worn transporting rollers 1, i.e. of worn circumferential surface areas 2 of the same, can therefore be influenced within limits. After the first colored portion 13 is worn the second colored portion 14 of the marking bodies 11 of pin-shaped design serves to indicate the degree of wear and indicates when the relevant transporting roller 1, whether of divided or not of divided design, is due to be exchanged.

Accordingly, the second colored portion 14 can be designed to be less thick than the thickness illustrated in FIGS. 1 and 2.

### LIST OF REFERENCE NUMBERS

1 divided transporting roller
1.1 first transporting roller half
1.2 second transporting roller half
2 circumferential surface area
3 axis of rotation
4 dividing joint
5 web
6 recess
7 first pin
8 second pin
9 first opening
10 second opening
11 marking body
12 colored setting-off
13 first colored portion
14 second colored portion
15 head of marking body
16 threaded portion
17 drive unit-housing
18 first vulcanized layer
19 second vulcanized layer
20 third vulcanized layer
21 bearing journal
22 clamping screw
23 roller body
24 first receiving opening
25 second receiving opening

1-12. (canceled)

13. A transporting roller with a drive unit assigned thereto, wherein the transporting roller comprises a body having a circumferential surface area (2) of an elastic material, the transporting roller being accommodated in the housing (17) of the drive unit for rotation about an axis of rotation, the improvement wherein the transporting roller (1) comprises at least one colored marking body (11) which penetrates the circumferential surface area (2), the marking body being composed of an elastic material and the abrasion properties of which correspond to those possessed by the elastic material (18, 19, 20) of the circumferential surface area (2), and the marking body (11) located in the circumferential surface area (2; 18, 19, 20) being colored such that it contrasts therewith and/or is fluorescent.

14. The transporting roller as claimed in claim 13, wherein the at least one marking body (11) is embedded into receiving openings (24, 25) formed in the circumferential surface area (2; 18, 19, 20) and extending into the roller body (23).

15. The transporting roller as claimed in claim 14, wherein the at least one marking body (11) is of pin-shape design and is vulcanized into the receiving openings (24, 25).

16. The transporting roller as claimed in claim 14, wherein the at least one marking body (11) is screwed into the receiving openings (24, 25).

17. The transporting roller as claimed in claim 13, wherein at least one marking body comprises a head region (15) of a first colored portion (13) that is colored such that it contrasts with the circumferential surface area (2) and/or is fluorescent.

18. The transporting roller as claimed in claim 14, wherein the receiving openings (24, 25) are designed such that they lie opposite each other or are offset in the circumferential surface area (2).

19. The transporting roller as claimed in claim 14, wherein the circumferential surface area (2) and the marking bodies (11) are manufactured from material with identical mechanical properties and are colored in differently.

20. The transporting roller as claimed in claim 17, wherein the at least one marking body comprises a second colored portion (14) of the at least one marking body (11) which is colored differently from the coloring of the first colored portion (13), and wherein the appearance of the second colored portion in the circumferential surface area (2, 18, 19, 20) indicates that the wear limit has been reached.

21. The transporting roller as claimed in claim 13, wherein a head (15) of the marking body (11) is embedded into the circumferential surface area (2) in a manner corresponding to the curvature thereof.

22. The transporting roller as claimed in claim 14, wherein a head (15) of the marking body (11) is embedded into the circumferential surface area (2) in a manner corresponding to the curvature thereof.

23. The transporting roller as claimed in claim 15, wherein a head (15) of the marking body (11) is embedded into the circumferential surface area (2) in a manner corresponding to the curvature thereof.

24. The transporting roller as claimed in claim 17, wherein a head (15) of the marking body (11) is embedded into the circumferential surface area (2) in a manner corresponding to the curvature thereof.

25. The transporting roller as claimed in claim 19, wherein a head (15) of the marking body (11) is embedded into the circumferential surface area (2) in a manner corresponding to the curvature thereof.

26. The transporting roller as claimed in claim 20, wherein a head (15) of the marking body (11) is embedded into the circumferential surface area (2) in a manner corresponding to the curvature thereof.

27. The transporting roller as claimed in claim 20, wherein the first colored portion (13) and the second colored portion (14) of the marking body (11) are designed in different thicknesses, and the thickness of the first colored portion (13) exceeds the thickness of the second colored portion (14) of the marking body (11).

28. The transporting roller as claimed in claim 26, wherein the first colored portion (13) and the second colored portion (14) of the marking body (11) are designed in different thicknesses, and the thickness of the first colored portion (13) exceeds the thickness of the second colored portion (14) of the marking body (11).

29. The transporting roller as claimed in claim 13, wherein the cross section of the marking bodies (11) is circular or oval.

30. The transporting roller as claimed in claim 14, wherein the cross section of the marking bodies (11) is circular or oval.

31. The transporting roller as claimed in claim 17, wherein the cross section of the marking bodies (11) is circular or oval.

32. The transporting roller as claimed in claim 20, wherein the cross section of the marking bodies (11) is circular or oval.
